(19) United States
(12) Patent Application Publication
(10) Pub. No.: US 2021/0016434 A1
(43) Pub. Date: Jan. 21, 2021

(54) RECOVERY SUPPORT DEVICE, RECOVERY TERMINAL DEVICE, COMPUTER PROGRAM, AND METHOD FOR MANUFACTURING SYSTEM

(71) Applicant: GS Yuasa International Ltd., Kyoto-shi, Kyoto (JP)

(72) Inventor: Tomikatsu UCHIHORI, Kyoto (JP)

(21) Appl. No.: 17/041,016

(22) PCT Filed: Mar. 14, 2019
(86) PCT No.: PCT/JP2019/010434

§ 371 Date: Sep. 24, 2020

(30) Foreign Application Priority Data
Mar. 30, 2018 (JP) 2018-070226

(51) Int. Cl. B25J 9/08; G06K 7/00; G06Q 10/10; G08B 13/24

(52) U.S. Cl. CPC B25J 9/08; G08B 13/2462; G06Q 10/10; G06K 7/0008

(57) ABSTRACT

A recovery support device includes: a storage unit that stores in advance user specification information for specifying a user; an extraction unit that extracts user specification information from the storage unit when an article is purchased, transferred free of charge, lent free of charge, or rented; a storage processing unit that stores tag identification information individually attached to a tag attached to the article or a tag that is the article in the storage unit in association with the user specification information extracted by the extraction unit; a reception unit that receives a detection notification including the tag identification information; and a notification unit that notifies the user and/or a system operator of the detection based on the user specification information associated with the tag identification information included in the received detection notification.

### TECHNICAL FIELD

The present invention relates to a recovery support device that supports recovery of articles including lost articles, a recovery terminal device, a computer program, and a method for manufacturing a system.

### BACKGROUND ART

Various systems have been proposed for notifying the owner of the discovery of a lost article (for example, see Patent Document 1). However, the amount of lost articles handled by the police or transportation has not decreased, and securing a place for storing and a human resource for managing lost articles in the police or transportation has become a problem.

In recent years, a system has been proposed that uses a tag including communication means by Bluetooth (registered trademark) and a communication device such as a smartphone communicating with the tag and that enables recovery of the tagged article when it is lost. In this system, upon interruption of the communication between the communication device owned by the owner and the tag, the fact that the tagged article was separated from the owner, that is, the article was lost, is notified, and the location where the communication was interrupted is detected by the location information acquisition function of the communication device to identify the place where the article was lost.

### PRIOR ART DOCUMENTS

### Patent Documents

Patent Document 1: JP-A-2008-210197

### SUMMARY OF THE INVENTION

### Problems to be Solved by the Invention

Despite the proposal of various systems, the problem related to handling of lost articles has not been fully solved. It is presumed that the system is not widely used due to the complexity of the registration procedure required for system use and operating costs.

From the standpoint of the institution or facility to which the lost article is delivered, in a system that requires a special reader as disclosed in Patent Document 1 or needs to operate a specific application as a business, the operation is complicated.

An object of the present invention is to provide a recovery support device, a recovery terminal device, a computer program, and a method for manufacturing a system, which are more convenient.

### Means for Solving the Problems

The recovery support device includes: a storage unit that stores in advance user specification information for specifying a user; an extraction unit that extracts user specification information from the storage unit when an article is purchased, transferred free of charge, lent free of charge, or rented; a storage processing unit that stores tag identification information individually attached to a tag attached to the article or a tag that is the article in the storage unit in association with the user specification information extracted by the extraction unit; a reception unit that receives a detection notification including the tag identification information; and a notification unit that notifies the user and/or a system operator of the detection based on the user specification information associated with the tag identification information included in the received detection notification.

As used herein, the term “detection” includes “pick up”, “delivery”, and “arrival”.

In the present specification, the “system operator” may be an operator who operates the entire system or an operator who operates a part of the system.

With the above configuration, for example, when an article is purchased, user specification information of a purchaser and tag identification information individually assigned to a tag attached to the article are associated with each other, and based on the tag identification information of the tag attached to the lost or illegally used article, notification to the user who is the owner (for example, the purchaser) or the system operator becomes possible. The user can enjoy the service of receiving notification when the article is lost or when the article is illegally used by a third party without the trouble of performing registration processing on the tag.

As used herein, the term “lost” includes “missing” and “stolen”.

The service of notifying when an article is lost or illegally used may be realized by a server that executes electronic commerce processing for accepting purchase, free transfer, free lending, or rental of an article, or may be executed outside the electronic commerce service.

If it is detected that an article has been picked up/delivered or illegally used, it is preferable to prepare an interface through which the user can select from among options including at least two of the following: recovery by the user to recover the article by himself, delivery by which it is transported through a distribution channel, submission on the electronic commerce service, and disposal.

The detection notification may include information indicating at least any of a place where the article was picked up/delivered or illegally used and/or a place where the article is stored. On the terminal device used by the user, a map may be displayed which shows the place where the article was picked up/delivered or illegally used or the place where the article is stored.

With the above configuration, the trouble of the procedure for the user can be reduced, and even if the article is delivered/detected to/at any facility, the recovery is facilitated and the convenience is enhanced. Therefore, the spread of the notification service at the time of loss or illegal use is promoted.

The computer program causes a computer including a reading unit that reads tag identification information from a tag attached with a barcode or an image, or a tag incorporating a wireless communication unit and a storage medium, and a storage unit to execute the steps of: storing facility identification information for identifying a facility in which the computer is installed in the storage unit in advance, and selecting a start of detection notification of an article; reading the tag identification information from the tag attached to the article by the reading unit; and notifying the detection of the article by associating the read tag identification information with the facility identification information stored in the storage unit.

The computer program causes a computer including a display unit and an operation unit to execute the steps of: causing the display unit to display a screen for accepting purchase, free transfer, free lending, or rental of an article; accepting a selection of an article by the operation unit; and causing the display unit to display a selection screen as to whether or not to receive a notification based on user specification information when the article is lost or illegally used in the purchase, free transfer, free lending, or rental procedure of the selected article.

The method for manufacturing a system, includes: distributing a first computer program so as to cause a first computer including a display unit and an operation unit to install the first computer program, the first computer program causing the first computer to execute the steps of causing a screen for accepting purchase, free transfer, free lending, or rental of an article to be displayed; accepting a selection of an article; and causing a selection screen as to whether or not to receive a notification based on user specification information when the article is lost or illegally used in the purchase, free transfer, free lending, or rental procedure of the selected article to be displayed; and distributing a second computer program so as to cause a second computer including a reading unit that reads tag identification information from a tag attached with a barcode or an image or a tag incorporating a wireless communication unit and a storage medium, and a storage unit to install the second computer program, the second computer program causing the second computer to execute the steps of storing facility identification information for identifying a facility in which the second computer is installed in the storage unit in advance, and selecting start of detection notification of an article; reading the tag identification information from the tag attached to the article by the reading unit; and notifying the detection of the article by associating the read tag identification information with the facility identification information stored in the storage unit.

### BRIEF DESCRIPTION OF THE DRAWINGS

FIG. 1 is a diagram showing an outline of a physical distribution system.

FIG. 2 is a block diagram showing internal configurations of a transaction server and a recovery support server.

FIG. 3 is a block diagram showing an internal configuration of a recovery terminal device.

FIG. 4 is a block diagram showing an internal configuration of an information terminal device.

FIG. 5 is a flowchart showing an example of a processing procedure in the transaction server.

FIG. 6 is a diagram showing an example of a screen provided by a mail-order service.

FIG. 7 is a diagram showing an example of a confirmation screen for associating tag identification information with account information.

FIG. 8 is a diagram showing an example of tag identification information associated with account information.

FIG. 9 is a schematic diagram showing an example of a tag.

FIG. 10 is a diagram showing an example of a screen including a list of tags associated with account information.

FIG. 11 is a diagram showing an example of a screen displayed on a display unit of the recovery terminal device.

FIG. 12 is a sequence diagram showing an example of a processing procedure at the time of picking up performed in the physical distribution system.

FIG. 13 is a diagram showing an example of a pick-up notification to a user.

FIG. 14 is a sequence diagram showing an example of a procedure of a recovery process performed in the physical distribution system.

FIG. 15 is a sequence diagram showing an example of a procedure of a recovery process performed in the physical distribution system.

FIG. 16 is a sequence diagram showing another example of the procedure of the recovery process performed in the physical distribution system.

### MODE FOR CARRYING OUT THE INVENTION

The present invention will be specifically described with reference to the drawings showing the embodiment. The embodiment described below is an example in which the recovery support device is applied to a physical distribution system.

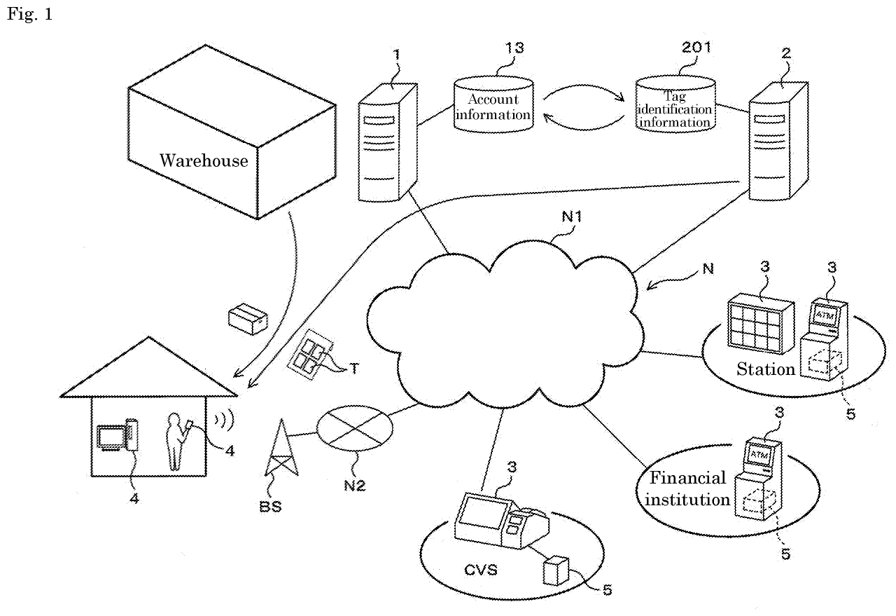

FIG. 1 shows an outline of a physical distribution system 100. The physical distribution system 100 includes a transaction server 1, a recovery support server 2, a recovery terminal device 3, and an information terminal device 4. The transaction server 1, the recovery support server 2, the recovery terminal device 3, and the information terminal device 4 can exchange information with each other via a network N. The physical distribution system 100 supplementally realizes a notification service at the time of loss. The notification service at the time of loss, if an article attached with a tag T is lost when the article sold by the electronic commerce (mail-order) service or the tag T itself sold is purchased, supports a user who is an owner (purchaser) in recovering this.

The transaction server 1 is a server computer managed by a business operator that provides a mail-order service. The user selects an article to purchase on the Web-based mail-order site provided by the transaction server 1. The transaction server 1 makes payment by the payment method associated with user's account information. The business operator carries out articles that have been settled or will be settled from the storage place (warehouse) and puts the articles on the distribution channel of the business operator or the distribution channel of the business operator or the logistics company affiliated with each seller, and deliver them to users. These are the basic mail-order services in the transaction server 1. The notification service at the time of loss, in such a mail-order service, distributes a tag T assigned with tag identification information associated with user specification information (hereinafter referred to as account information) that can specify a user together with an article, and supports the recovery of a lost article.

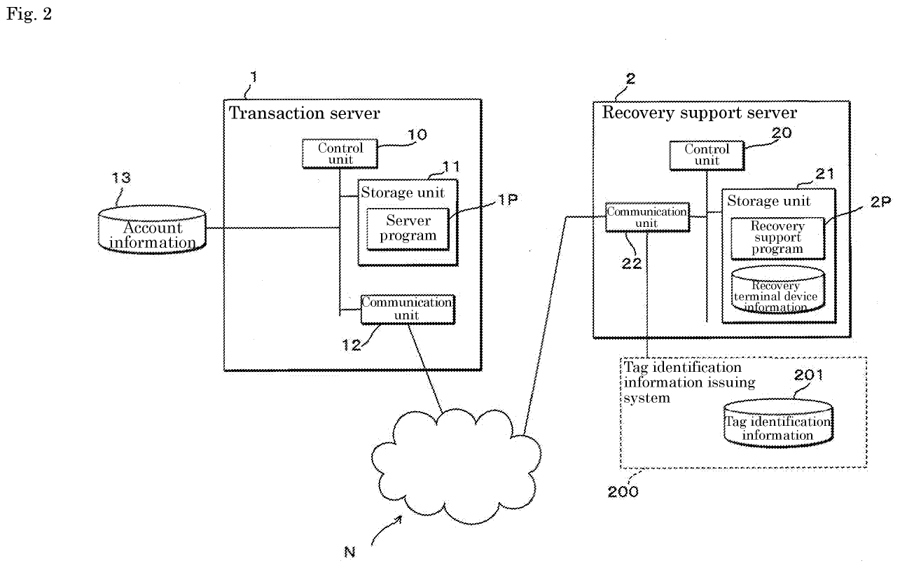

The recovery support server 2 is a server computer managed by the provider of the tag T. The recovery support server 2 groups and stores tag identification information assigned to each tag T before distribution, and provides the tag identification information to the transaction server 1. The recovery support server 2 can communicate with the recovery terminal device 3. The tag identification information assigned to the tag T is issued by an issuing system 200 (see FIG. 2) managed by the recovery support server 2 or another affiliated system, and is managed in association with the issue date by the issuing system 200 so that different tags T do not overlap each other.

The recovery terminal device 3 is an existing terminal device installed and used in a facility to which lost articles are delivered, for example, a convenience store, a station of public transportation, or a business facility. The recovery terminal device 3 may be the one to which a general-purpose communication device such as a tablet terminal or a smartphone is applied. The delivery destination of the article is not limited to the above example, but may be a police station or a commercial facility, and the recovery terminal device 3 may be provided in these facilities. When installed in a convenience store, the recovery terminal device 3 may be a cashier terminal, an ATM (Automatic Teller Machine), or a kiosk terminal that provides a ticket sales service at a convenience store. The recovery terminal device 3, when installed in a public transportation facility such as a station, may be an ATM, a receiving locker, or a reception terminal (installed at a place where check-in is required such as an airport). The recovery terminal device 3 may be an ATM provided in a facility of a financial institution, or a cashier terminal, an ATM, or a kiosk terminal in a commercial facility. The recovery terminal device 3 may be provided as a new dedicated terminal at each place, or may be realized by adding a function as the recovery terminal device 3 to an existing terminal device by software (described later). The existing terminal device for functioning as the recovery terminal device 3 may be equipped with an uninterruptible power supply (UPS) 5 or may be connected to the UPS 5. The additional software module may be provided by the UPS 5 provider together with the above recovery support server 2.

The information terminal device 4 is a personal computer, a smartphone or a tablet terminal device used by a user. The information terminal device 4 can execute an application program including at least a Web browser, and is communication-connected to the transaction server 1 to enable a user to buy and sell articles at a mail-order site provided by the transaction server 1.

The network N includes a public communication network Ni which is so-called the Internet and a carrier network N2 which realizes wireless communication according to a predetermined mobile communication standard. The carrier network N2 includes a base station BS. Communication connection is possible between the transaction server 1 and the recovery support server 2, and between the recovery support server 2 and the recovery terminal device 3 via the network N. The information terminal device 4 can communicate with the transaction server 1 from the public communication network N1 or the base station BS via the network N.

Lost article recovery in the physical distribution system 100 is realized as follows. First, the mail-order site provided by the transaction server 1 sells the tag T in the same manner as the article, or makes the tag T an accessory of the article purchased. At the time of selling the article or the tag T, the tag identification information assigned to the tag T that is an accessory of the article or the tag T that is the sale target is associated with the account information of the user for using the transaction server 1. It is desirable to get user's approval for the association. After that, the tag T is delivered to the user who is the purchaser. The delivery destination is a user's home, work place, or a designated address such as a convenience store. In the sales form in which the seller performs processing such as packing the article after the purchase application is made at the mail-order site, the tag T may be attached to the article in advance by the seller.

The tag T stores each tag identification information so that it can be read easily. The tag T can be provided in various ways. The tag T may be provided as a seal on which an image obtained by one-dimensionally or two-dimensionally encoding the tag identification information is printed. The tag T may be provided as a seal incorporating a layer in which an IC chip that stores tag identification information of a wireless tag (e.g., RFID) and a conductor constituting an antenna is formed, or a string-shaped ribbon or the like. The tag T may be provided in the form of a baggage tag or a key chain incorporating a communication module using Bluetooth (registered trademark), particularly BLE (Bluetooth Low Energy), and an IC chip in which tag identification information is stored. Each tag T may be made to imitate a character, or may have an image printed thereon to be used as an ornament. The tag T may also be used as a seal for identifying a source or an authenticity determination seal including a trademark or the like relating to an article to be attached to, or a tag or a label attached to an article such as clothing. The user need only attach the tag T to the purchased article or attach the purchased tag T to the owned article. The tag T may be the IC chip itself storing the tag identification information. In this case, the article and the tag T are integrated. For example, cards such as a cash card with an IC chip, a credit card, and a point card, and portable electronic devices including a smart phone with a built-in IC chip function as the tag T. The IC chip may be incorporated in articles that are easily lost, such as umbrellas and clothes.

The recovery terminal device 3 has a function of reading the tag identification information from the tag T, and when the user's article is delivered as a lost article, notifies the recovery support server 2 of the tag identification information read from the tag T attached to the article together with the information indicating the delivery destination. The recovery support server 2 notifies the transaction server 1 of the tag identification information about the delivered article based on the notification from the recovery terminal device 3, and within the service provided by the transaction server 1, notifies the user that the lost article has been recovered, based on the account information associated with the tag identification information. The notification may be realized by notification to the information terminal device 4, or when the lost article is the information terminal device 4 itself, by delivery of a postcard, a sealed letter, or the like to the address corresponding to the account information, or by telephone contact.

The user who has received the notification that the article was delivered refers to the information indicating the delivery destination included in the notification and goes to the delivery destination to recover the article. The notification preferably includes options for delivery, disposal, sale, etc. of the article. At the time of recovery, recovery is performed only when it is confirmed that the user is the owner by reading of a tag T again with the recovery terminal device 3 and by collation with the account information associated with the tag identification information of the tag T. The account information may be a name, an address, a user identification number and password in the mail-order service, or biometric authentication information such as a face or a fingerprint, and it is preferable that the identity is confirmed by these pieces of information. The account information may include a temporarily issued password or may be replaced by this temporary password.

As described above, in the lost article recovery support in the physical distribution system 100, the user, when purchasing the article or the tag T, only have to agree with the association between the account information of the mail-order service or the payment service used for the purchase and the tag identification information of the tag T and attach the tag T to the article. The report/register of lost article may be made not only to the police station but also to the convenience store, train station, financial institution, and the like, and in any case, delivery and receipt are performed safely. Personal information about the user (user specification information) does not have to be seen by others. The configuration of each device that enables such lost article recovery support will be described in detail.

FIG. 2 is a block diagram showing the internal configuration of the transaction server 1 and the recovery support server 2. The transaction server 1 includes a control unit 10, a storage unit 11, and a communication unit 12. In the present embodiment, the transaction server 1 is described as a single server computer, but the functions or processes may be distributed among a plurality of server computers.

The control unit 10 is a processor using a CPU (Central Processing Unit) or a GPU (Graphics Processing Unit), uses a built-in memory such as a ROM (Read Only Memory) and a RAM (Random Access Memory), and controls each component to execute processing. The control unit 10 executes information processing based on a server program 1P stored in the storage unit 11. The server program 1P includes a Web server program, and the control unit 10 functions as a Web server that executes provision of a Web page that is a mail-order site to the information terminal device 4, reception of login to the Web service, and the like.

The storage unit 11 uses a non-volatile memory such as a hard disk or a flash memory. The storage unit 11 stores various information referred to by the server program 1P and the control unit 10 described above.

The communication unit 12 is an interface that realizes communication via a network N, and uses a communication interface such as Ethernet (registered trademark) or a wireless communication antenna, for example. The control unit 10 can be communication-connected to the recovery support server 2 via the communication unit 12.

The transaction server 1 can read/write information from/to the storage device 13 that stores the account information of the user of the service to be provided. The control unit 10 of the transaction server 1 adds/deletes account information to/from the storage device 13, and performs updating, reading, or the like of the account information.

The recovery support server 2 includes a control unit 20, a storage unit 21, and a communication unit 22. The recovery support server 2 is also described as a single server computer, but the functions or processes may be distributed among a plurality of server computers.

The control unit 20 is a processor using a CPU, uses a built-in memory such as a ROM and a RAM, and controls each component to execute processing. The control unit 20 executes information processing based on a recovery support program 2P stored in the storage unit 21.

The storage unit 21 uses a non-volatile memory such as a hard disk or a flash memory. The storage unit 21 stores various information referred to by the recovery support program 2P and the control unit 20 described above. The storage unit 21 stores, as the recovery terminal device information, the correspondence between the terminal identification information of the recovery terminal device 3 and the specific information (name and position information) for identifying the facility where the recovery terminal device 3 is installed.

The communication unit 22 is an interface that realizes communication via the network N and a dedicated line. The control unit 20 realizes the communication connection with the transaction server 1 via the network N or the dedicated line by the communication unit 22. The control unit 20 can be communication-connected to the recovery terminal device 3, and is preferably connected via a dedicated line.

The recovery support server 2 can transmit and receive information to and from the issuing system 200 including the storage device 201 that stores the group correspondence of the tag identification information assigned to the tag T. The storage device 201 groups and stores the tags T. When the tag T is sold as a single article, the tag identification information assigned to the tag T is stored in association with information corresponding to the type and classification of the tag T (classification identification information), and information indicating the provider of the tag T (management company of the transaction server 1). The tag identification information is preferably stored in association with attribute information such as the issue date and the manufacturing date. When the tag T is sold as a package including a plurality of tags T, the representative tag identification information among the packaged plurality of tags T is stored in association with the classification identification information of the tag T and the information indicating the provider. Group identification information may be issued for each group (package), and the tag identification information of the tag T may be associated with the group identification information of the group to which it belongs. It is desirable that the attribute information is also associated with the group identification information. The control unit 20 of the recovery support server 2 performs issuance of the tag T, inquiry about the tag identification information of the issued tag T, and the like to the issuing system 200.

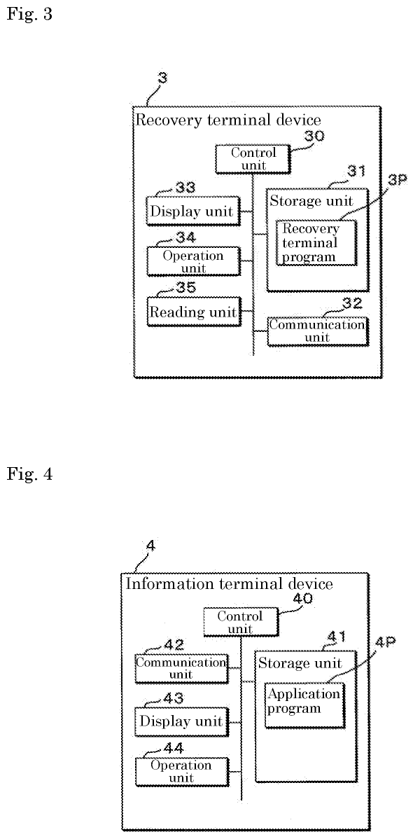

FIG. 3 is a block diagram showing an internal configuration of the recovery terminal device 3. As described above, as the recovery terminal device 3, a cashier terminal, an ATM, a kiosk terminal, a receiving locker, or a new terminal device is used. The recovery terminal device 3 may be a general-purpose tablet terminal used as a cashier terminal. The recovery terminal device 3 includes at least a control unit 30, a storage unit 31, a communication unit 32, a display unit 33, an operation unit 34, and a reading unit 35. The recovery terminal device 3 may have various components according to the type of device used.

The control unit 30 is a processor using a CPU, uses a built-in memory such as a ROM and a RAM, and controls each component to execute processing. The control unit 30 executes information processing based on a recovery support program 2P stored in the storage unit 31.

The storage unit 31 stores a recovery terminal program 3P. The recovery terminal program 3P may be provided as a coordination program such as a plug-in module for a cashier software program in case of a cashier terminal and an ATM software program in case of an ATM.

The communication unit 32 is an interface that realizes communication via a dedicated line. The control unit 30 can communicate with a server device corresponding to each terminal function via the communication unit 32 and via the corresponding dedicated line.

The display unit 33 uses a display such as a liquid crystal display or an organic EL (Electro Luminescence) display. The display unit 33 displays an operation screen including characters and images by processing based on a terminal program including the recovery terminal program 3P of the control unit 30. The display unit 33 uses a display with a built-in touch panel. The display unit 33 is not essential, and when the operation unit 34 is used as a user interface by voice, information may be output by voice instead of the display unit 33.

The operation unit 34 uses a touch panel with a built-in display of the display unit 33, or buttons provided on the housing of the recovery terminal device 3. The operation unit 34 may be a voice input unit and may accept an operation by voice with a voice recognition function. The operation unit 34 may be a keyboard and pointing device capable of inputting/outputting with the control unit 30. With these configurations, the operation unit 34 notifies the control unit 30 of operation information by a user or an operator.

The reading unit 35 is a reader that reads the tag identification information of the tag T. The reading unit 35 is at least one of a barcode reader, a camera, and a wireless tag reader. The reading unit 35 may include any of them, and selectively use any one depending on the mode of the tag T to read the tag identification information of the tag T. The reading unit 35 notifies the control unit 30 of the information read from the tag T.

FIG. 4 is a block diagram showing an internal configuration of the information terminal device 4. The information terminal device 4 is a personal computer, a smartphone, or a tablet terminal device used by the user as described above, and includes a control unit 40, a storage unit 41, a communication unit 42, a display unit 43, and an operation unit 44.

The control unit 40 uses a processor such as a CPU and a GPU and a memory and the like. The control unit 40 may be configured as one piece of hardware (SoC: System On a Chip) in which a processor, a memory, the storage unit 41, and the communication unit 42 are integrated. The control unit 40 executes a communication connection to the transaction server 1 based on an application program 4P stored in the storage unit 41, and executes a process via a web page related to mail order provided by the transaction server 1.

The storage unit 41 uses a flash memory, and stores a program and data referred to by the control unit 40 including the application program 4P. The application program 4P includes at least a Web browser program, and the control unit 40 causes the display unit 43 to display a screen based on the information of the Web page provided by the transaction server 1 based on the application program 4P.

The communication unit 42 is a communication module that realizes communication connection to the network N. The communication unit 42 uses a network card, a wireless communication device, or a carrier communication module.

The display unit 43 uses a display device such as a liquid crystal panel or an organic EL display. The operation unit 44 is an interface that accepts a user operation, and uses physical buttons, a touch panel device with a built-in display, a speaker, a microphone, and the like. The operation unit 44 may accept an operation on the screen displayed on the display unit 43 by a physical button or a touch panel, or may accept an operation in an interactive form by recognizing an operation content from an input voice by a microphone and outputting a voice by a speaker.

In the physical distribution system 100 configured as described above, even if an article is lost, a tag T is attached to the article, so that it is possible to recover the article while reducing the operation load on the user who is the owner. The processing in each phase will be described below by dividing it into (1) an acquisition phase of the tag T, (2) a phase from loss to pick up, and (3) a recovery phase.

### (1) Acquisition of Tag T

In the acquisition phase of the tag T, the user acquires the article to which the tag T is attached or the tag T itself.

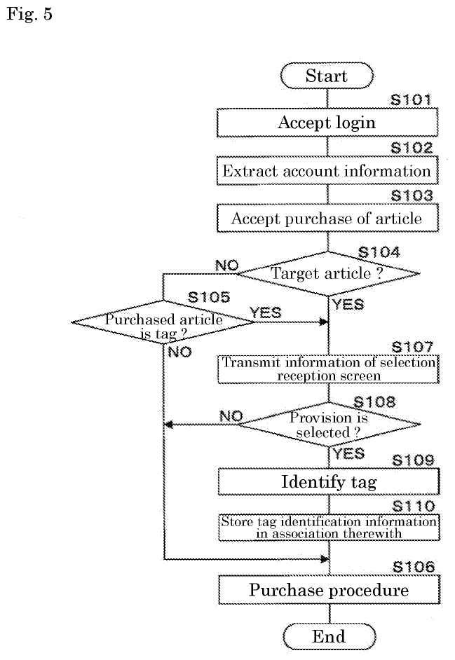

FIG. 5 is a flowchart showing an example of the processing procedure in the transaction server 1. Due to the function of the Web server, the control unit 10 of the transaction server 1 starts the following processing upon accepting an access from the information terminal device 4 used by the user.

The transaction server 1 accepts login on the web page of the mail-order service provided (step S101). The information used for login is not limited to so-called login information such as user ID (Identifier) and password, as long as it is information that can specify a user who uses the information terminal device 4, may be a user name, other authentication information (biological information, key information) etc., and the format does not matter. Information for logging in to another service may be used to enable linkage with another service, and an open ID may be used. The control unit 10, based on the information used for login, extracts the account information of the user who uses (user name, user identification number, contact destination (phone number, address, etc.), member category, account information in other linked services, etc.) from the storage device 13 (step S102).

The control unit 10 accepts the purchase of the article (or information) in the mail-order service provided (step S103). The control unit 10 determines whether or not the article to be purchased is a target article of the tag T (step S104). It may be possible to determine whether or not the article is the target article of the tag T based on the category of the article, or to store the product number of the target article in advance and determine whether or not the article is the target article.

When it is determined in step S104 that the article is not the target article (S104: NO), the control unit 10 determines whether or not the article to be purchased is the tag T itself (step S105). When it is determined in step S105 that the article is neither the target article nor the tag T itself (S105: NO), the control unit 10 advances the purchase procedure (step 5106) and ends the process.

If it is determined in step S104 that it is a target article (S104: YES), or if it is determined in step S105 that it is the tag T itself (S105: YES), the control unit 10 transmits information of a screen for accepting a selection as to whether or not to receive provision of the warranty service at the time of loss to the information terminal device 4 (step S107). The control unit 10 determines whether or not it has been selected to receive the provision on a selection reception screen (step S108). On the selection screen transmitted in step S107, it is desirable to confirm whether to agree on the association between the tag identification information assigned to the tag T and the account information in the mail-order service.

When it is determined in step S108 that it is selected to receive the provision (S108: YES), the control unit 10 identifies the tag T as an accessory or the tag T as an article to be purchased (step S109), and stores the tag identification information of the identified tag T in the storage device 13 in association with the account information identified in step S102 (step S110). The association and storage in step S110 are not limited to during the purchase procedure so far. After the purchase procedure, when the tag T is actually carried out from the warehouse or when the tag T is shipped to the purchaser, the actual tag identification information may be read from the tag T, and stored in association with the purchaser's account information.

The control unit 10 continues the purchase procedure of the article as it is (S106), and ends the process. In step S106, when the purchase target is the tag T itself and when the application for the supplementary service of the notification at the time of loss is accepted as an accessory, the control unit 10 calculates additional charges, fees, etc. and continues the procedure. When the account information identified in step S102 is a specific member, the control unit 10 proceeds with the procedure without performing additional calculations such as additional charges and fees as accessories.

The flowchart of FIG. 5 is an example. The processes of steps S101 and S102 may be performed immediately before the purchase procedure of step S106.

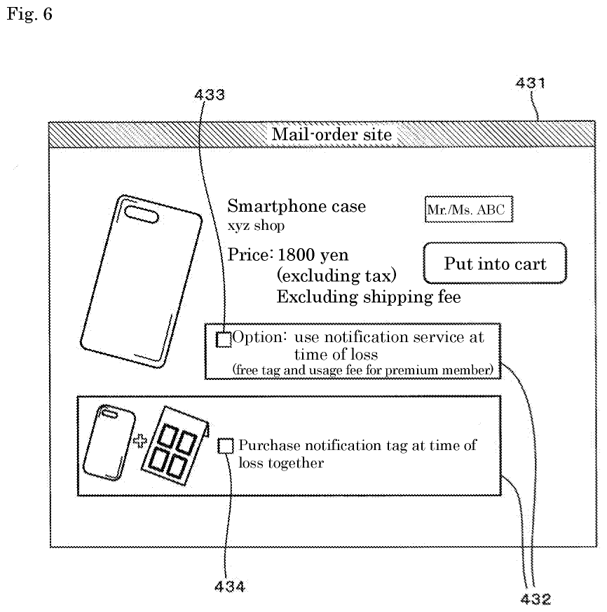

FIG. 6 is a diagram showing an example of a screen provided by the mail-order service. FIG. 6 shows an article purchase procedure screen 431 displayed on the display unit 43 of the information terminal device 4. The purchase procedure screen 431 includes a selection reception screen 432 which is displayed when it is determined that the article is the target article in step S104 described above, and the screen 432 includes a selection control 433 for selecting registration in the notification service at the time of loss. The selection reception screen 432 may include a control 434 that separately accepts the purchase of the tag T together. When the selection control 433 or control 434 is selected and the purchase procedure is proceeded, the tag T is delivered together with the purchased product and is a target for using the notification service at the time of loss as the supplementary service (optional) of the mail-order service provided by the transaction server 1. The tag T may be separately delivered from the issuing system 200.

FIG. 7 is a diagram showing an example of a confirmation screen for associating the tag identification information with the account information. The screen shown in FIG. 7 is displayed on the display unit 43 of the information terminal device 4 when the selection control 433 or the control 434 on the selection reception screen 432 is selected in FIG. 6 (when “put into cart” is selected). In step S110, it is desirable that the association with the account information be approved on the screen as shown in FIG. 7. If disapproval is selected, the purchase procedure of the article simply proceeds. As shown in FIG. 7, it is preferable to select any of notification to the email address corresponding to the information terminal device 4 used by the user included in the account information, notification by postcard to the address included in the account information, or notification to the application associated with the account information. The control unit 10 stores in the storage device 13 which one should be notified in association with the account information.

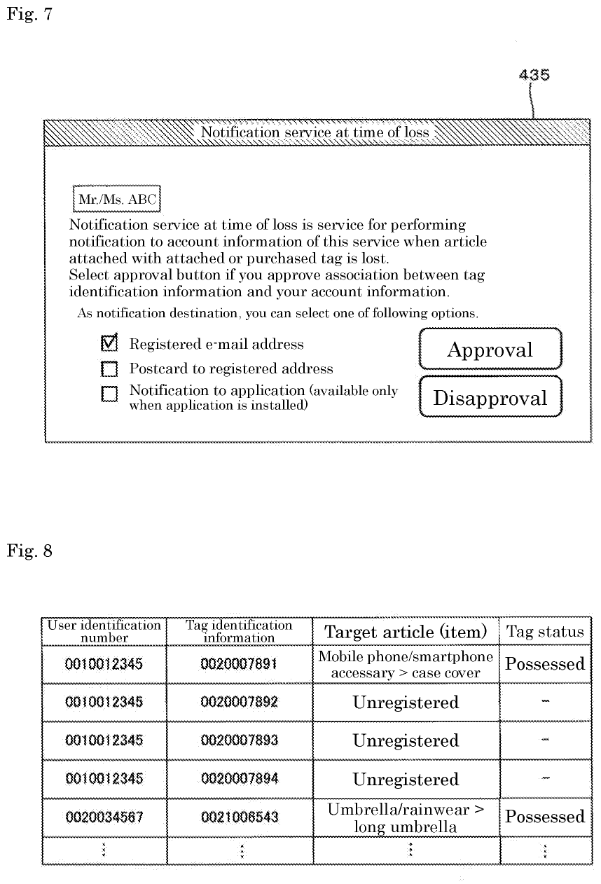

FIG. 8 is a diagram showing an example of tag identification information associated with account information. As shown in FIG. 8, in step S110 described above, the tag identification information of the tag T is stored in association with the account information. In the example shown in FIG. 8, the user identification number “0010012345” that specifies the user assigned to the user ID (login ID) is used as a part of the account information, and in association with this, the tag identification information “0020007891” to “0020007894” of four tags T that have been purchased as a package (purchased with the control 434 in FIG. 7) is stored. An example is shown in which the tag identification information “021006543” of one tag T is associated with the user identification number “0020034567” as an accessory of the article (item: long umbrella). One of the plurality of tags T is stored in association with the product name (item) of the article purchased together. The tag identification information of the other tag T indicates that the item is unregistered. Regarding the grouped tags T including the representative tag identification information “0020007891”, unregistered items may be separately registered after the tag T is attached to the property as a supplementary service of the account information of the mail-order service. As shown in FIG. 8, the tag identification information of each tag is preferably associated with the information indicating a tag status. The tag status will be explained in the later-described phase of “from loss to pick up”.

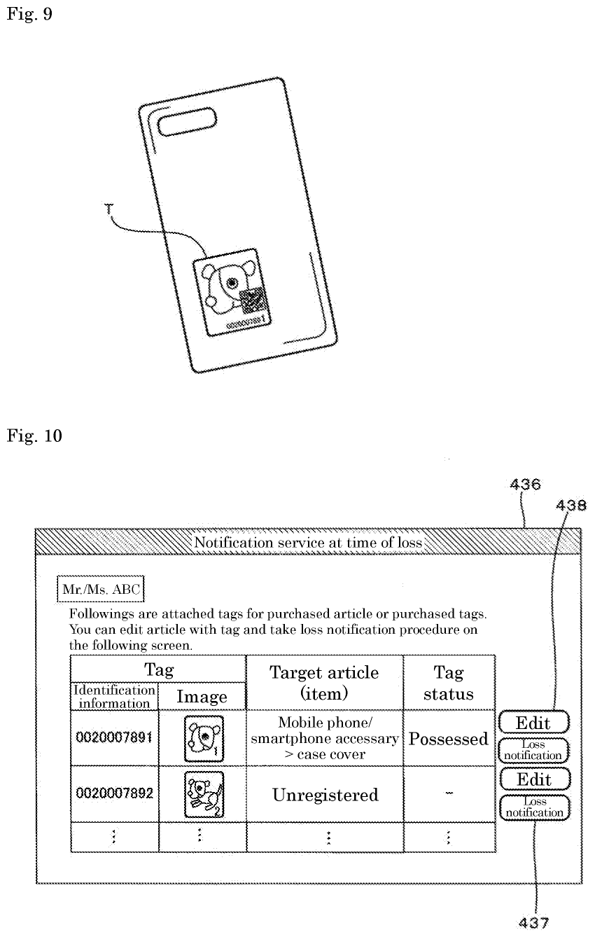

By the processing of the purchase procedure as shown in the flowchart of FIG. 5, the tag T is delivered to the user together with the purchased article or separately. The user attaches the acquired tag T to the purchased article with his/her own hand. FIG. 9 is a schematic diagram showing an example of the tag T. As shown in FIG. 9, the tag T may be in the form of a seal, in which case the user attaches the one sent together with the purchased article to the article. An image of a character is printed on the seal-like tag T shown in FIG. 9 and is used as an ornament.

By placing the tag T together with other services in the distribution of articles and associating the user's account information with the tag T in the purchase procedure of the articles, it is unnecessary for the user to separately perform a registration procedure for the tag T, and convenience is enhanced.

### (2) From Loss to Pick Up

Next, the phase after the article with the tag T is lost will be described. When the user realizes that the article with the tag T has been lost, he/she logs in to the mail-order service provided by the transaction server 1 at the information terminal device 4 that he/she owns, and registers the lost article (loss notification procedure). Loss notification procedures are not mandatory. When the use of notification service at the time of loss is selected, for example, a screen including a list of tags T associated with account information can be displayed. FIG. 10 is a diagram showing an example of a screen 436 including a list of tags T associated with account information. As shown in FIG. 10, when it is displayed on the display unit 43 of the information terminal device 4, it is preferable that an image diagram of each tag T purchased by the user is displayed, and the user can identify the article with the tag T for each tag T. The screen 436 including the tag list shown in FIG. 10 includes a loss notification button 437 for registering the type (item) of the lost article. The loss notification button 437 may be linked to a service for submitting a loss notification form to the police, or may be linked to a service for notifying the existence of the article with the tag T attached by separately using a gate (beacon receiver, etc.) equipped with a reader that can read the tag identification information from the tag T. The linked service will be described later. The screen 436 of the tag list includes an interface (edit button 438) that enables the posterior registration of the item and the type of the article to which the tag T is attached, even if the article is not lost.

In the screen example of FIG. 10, when the loss is registered by the loss notification button 437, the tag identification information of the tag T associated with the account information shown in FIG. 8 is updated in the tag status from “possessed” to “lost”. The recovery support server 2 is notified that the article is lost in association with the tag identification information of the tag T supposed to be attached to the lost article, and the recovery support server 2 stores the tag identification information of the lost tag Tin the storage unit 21. The update of the tag status to “lost” is not essential, and the tag status may be directly updated from “possessed” to “already picked up” or the like due to the fact that the article has been picked up as described later.

If a well-meaning third party picked up a lost article, the third party delivers the article to staff at any facility. The staff tries to read the tag T of the article by the reading unit 35 of the recovery terminal device 3 that manages the delivered article. When the tag T is attached to the article, the recovery terminal device 3 notifies the recovery support server 2. Reading is done as follows. When the third party who has picked up is a specific member of the mail-order service, the account information may be registered at the recovery terminal device 3 as a finder.

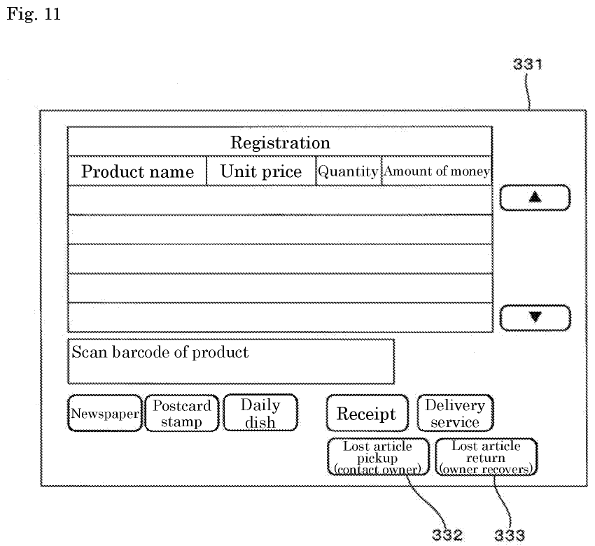

FIG. 11 is a diagram showing an example of a screen displayed on the display unit 33 of the recovery terminal device 3. FIG. 11 shows an example of a screen displayed based on the recovery terminal program 3P, which is the basis of the operation of the recovery terminal device 3, and more specifically, shows an example when the recovery terminal device 3 is a cashier terminal of a convenience store. As shown in FIG. 11, a cashier screen 331 displayed on the cashier terminal functioning as the recovery terminal device 3 includes a lost article pickup button 332 which is used to contact the owner when a lost article is picked up along with the delivery procedure. The cashier screen 311 also includes a lost article return button 333 used when the user recovers the lost article, as described later.

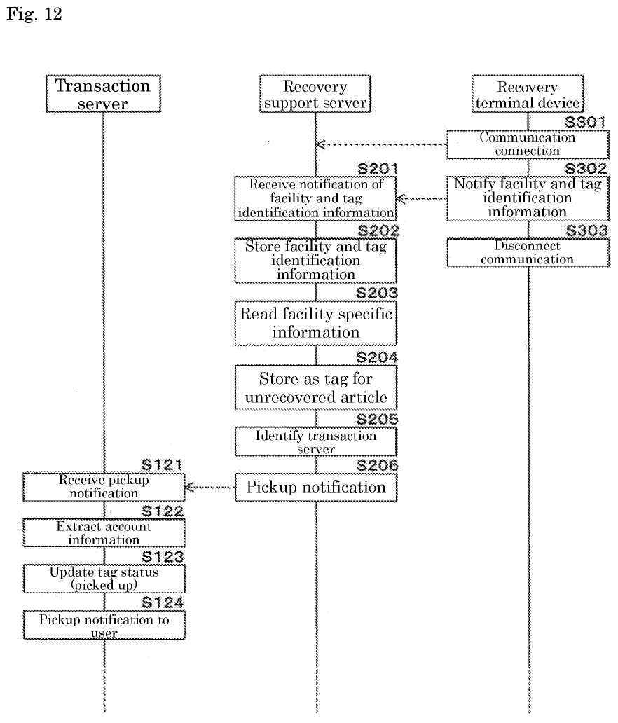

Like the lost article pickup button 332 shown in FIG. 11, the display unit 33 or the operation unit 34 included in the recovery terminal device 3 is provided with an interface for notifying the pick up. When the staff performs an operation of selecting an interface for notifying the pick up, a message prompting the reading unit 35 to read the tag T is displayed on the display unit 33. The display unit 33 may display an interface for selecting the item of the picked-up article. When the reading operation is performed, when the notification of the tag identification information read from the reading unit 35 is received in the state of notifying the pick up, the following processing is executed from the recovery terminal device 3 as a starting point. FIG. 12 is a sequence diagram showing an example of a processing procedure at the time of pick up performed in the physical distribution system 100.

The control unit 30 of the recovery terminal device 3 connects to the recovery support server 2 from the communication unit 32 (step S301). When the connection is established by the recovery support server 2, the tag identification information of the tag T read by the reading unit 35 together with the facility identification information preliminarily stored in the storage unit 31 is notified together with the item of the article, when the item is selected (step S302). When the notification is completed, the communication is disconnected (step S303). After disconnection in step S303, a message indicating completion of the notification may be displayed on the display unit 33 of the recovery terminal device 3.

In the recovery support server 2, upon receiving the notification from the recovery terminal device 3 communication-connected by the communication unit 22 (step S201), the control unit 20 temporarily stores the notified tag identification information of the tag T and facility identification information (step S202). If the item of the article is notified, this is also stored. The control unit 20 reads the specific information (name and location information) of the facility based on the facility identification information (step S203). The control unit 20 stores the notified tag identification information of the tag T and the identification information of the facility to which the article was delivered (including the item if notified) as the information of the tag T attached to the article that has been picked up but not recovered in the storage unit 21 (step S204).

Based on the tag identification information of the tag T, the control unit 20 inquires of the issuing system 200 about the information that identifies the transaction server 1 whose provider of the tag T identified by the information of the provider of the tag T is an administrator (step S205).

Based on the information obtained as a result of the inquiry, the control unit 20 transmits, toward the transaction server 1 to which the tag T is provided, the pick-up notification (detection notification indicating having detected the pick up) including the tag identification information of the picked-up tag T and the specific information of the facility where the article was picked-up (step S206).

In the transaction server 1, when the communication unit 12 receives the pick-up notification (step S121), the control unit 10 extracts, from the storage device 13, the account information associated with the tag identification information of the tag T included in the pick-up notification (step S122). The control unit 10 updates, among the tag identification information of the tag T associated with the extracted account information, the tag status information corresponding to the tag identification information of the tag T included in the pick-up notification with the information such as “already picked up” (step S123). The control unit 10 notifies the user of the pick up to a notification destination (FIG. 7) preliminarily selected from among the e-mail address, address, and application program 4P of the information terminal device 4 included in the extracted account information (step S124), and then ends the processing.

In this way, in the facility where delivery was made, the staff operates the interface for pick-up notification on the recovery terminal device 3 and performs the reading operation in the reading unit 35. The management of the picked-up articles should be stored according to the agreement of each facility. In the case of a receiving locker, it is preferable that the picked-up articles are stored by the staff in each room of the locker, automatically locked by the recovery terminal device 3, and unlocked by the personal identification number (authentication by password or account information may be used) notified to the owner described below. In addition, if the facility where the article was picked up and delivered is a large-scale commercial facility that has a warehouse and the warehouse has an automatic material handling device, the picked-up articles may be automatically stored and automatically recovered.

When the third party who has picked up is a specific member of the mail-order service, and registers the account information at the recovery terminal device 3 as a finder, it is preferable to perform reading of the account information of the finder as an option after reading the tag identification information of the tag T in the reading unit 35. On the information terminal device 4 carried by the finder, it is preferable that the account information is imaged and displayed as a barcode or the like on the display unit 43, and this is read by the reading unit 35 of the recovery terminal device 3 and transmitted to the recovery support server 2 in association with the tag identification information of the tag T of the picked-up article.

### (3) Recovery of Articles

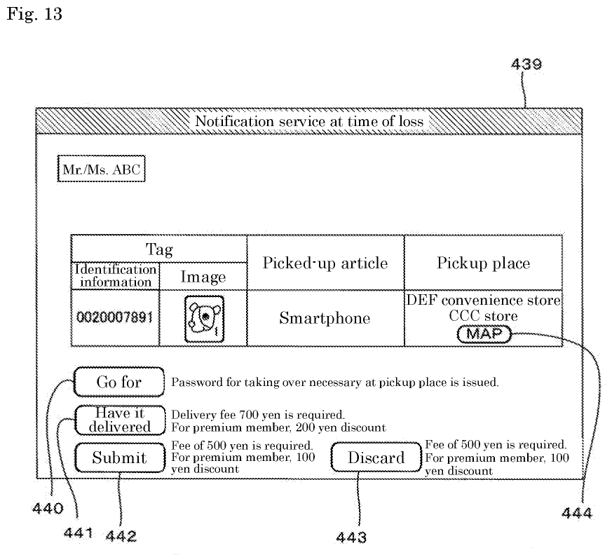

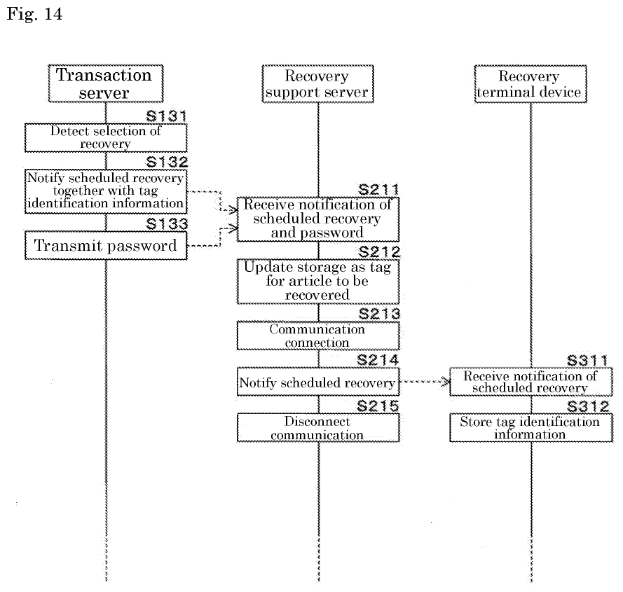

FIG. 13 is a diagram showing an example of a pick-up notification to the user. FIG. 13 shows a pick-up notification screen 439 displayed on the display unit 43 of the information terminal device 4. The pick-up notification screen 439 includes an image of the tag T, the item of the delivered article, and information for identifying the pick up place. The pick up place also includes a button 444 for displaying a map showing the place. The pick-up notice screen 439 includes an interface for selecting a user's action for the picked-up article. The interface includes an icon 440 to start the procedure when the user goes to pick up, an icon 441 to have it shipped to his/her home in the same manner as shipping by the mail-order service, and an icon 442 to abandon the recovery and perform a submission procedure on the mail-order service. As shown in FIG. 13, the pick-up notification screen 439 may include an icon 443 to perform a disposal procedure. When the address is selected as the notification destination, the personal identification number for picking up is issued and notified by the postcard on which it is described. In the case of a postcard, it is preferable to describe the operation method by telephone regarding the procedure corresponding to the icon 441 for receiving the delivery and the icon 442 for submission. As shown in FIG. 13, if the picked-up article is a smartphone and the selected notification destination is an email address or a notification to the application program 4P, it is preferable that the control unit 10 of the transaction server 1 recognizes this and takes measures such as notifying by postcard.

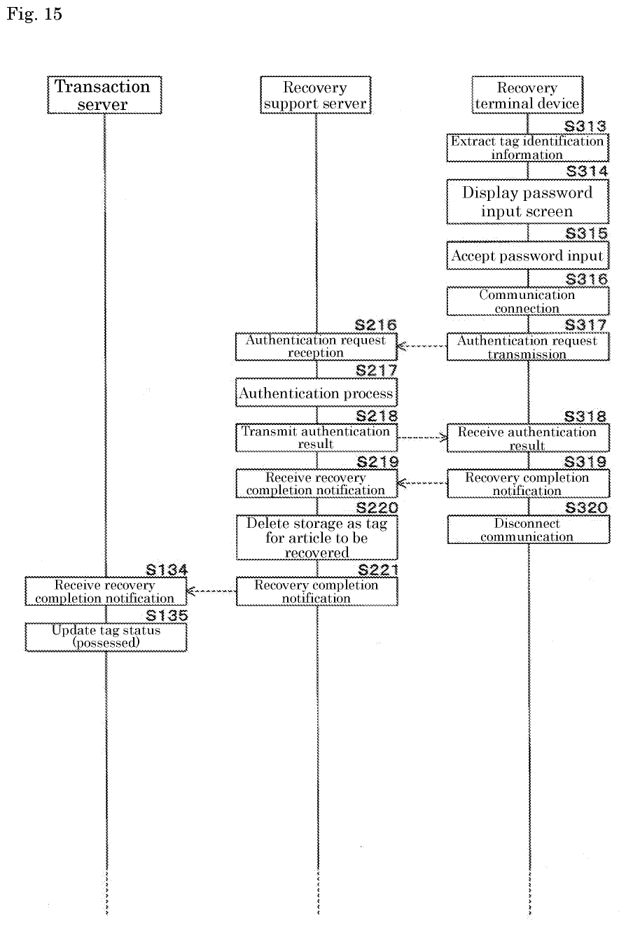

When the user selects an action, the recovery process is started by the transaction server 1 that has detected the action. First, a case where going to pick up (recovery) is selected will be described. FIGS. 14 and 15 are sequence diagrams showing an example of a procedure of the recovery process performed in the physical distribution system 100.

The transaction server 1, when having detected that the recovery has been selected (step S131), notifies the recovery support server 2 that the recovery is scheduled along with the tag identification information of the target tag T (step S132). The transaction server 1 issues the password for taking over, encrypts it, etc., and then securely transmits it to the recovery support server 2 in association with the tag identification information of the tag T (step S133).

In the recovery support server 2, when the notification of the scheduled recovery and the password are received from the transaction server 1 by the communication unit 22 (step S211), the control unit 20 updates the notified tag identification information of the tag T stored in the storage unit 21 in step S204 and the identification information of the facility where the article was delivered as the information of the tag T attached to the article to be recovered (step S212). The control unit 20 communication-connects to the recovery terminal device 3 of the facility where the article was delivered and stored based on the identification information of the facility associated with the notified tag identification information of the tag T (step S213), and notifies the scheduled recovery in association with the tag identification information of the tag T of the article to be recovered (step S214). When the notification is completed, the communication connection is disconnected (step S215). In step S214, information indicating the recovery deadline may be associated and transmitted.

The recovery terminal device 3, when having received the notification of the scheduled recovery (step S311), stores the tag identification information of the tag T of the article to be recovered included in the notification in the storage unit 31 and waits (step S312).

The user, who is the owner of the lost article goes to the facility to which the lost article has been delivered, and thereby the recovery process proceeds at the recovery terminal device 3. For example, when the user calls out to the staff of the facility, the processing by the recovery terminal device 3 is started by the operation or guidance of the staff. The control unit 30 of the recovery terminal device 3 extracts the tag identification information of the tag T corresponding to the article to be recovered from the information of the scheduled recovery stored in the storage unit 31 (step S313). In step S313, for example, the staff takes out the article designated by the user from the storage place, the user visually checks the article, the reading unit 35 reads the tag T attached to the article, and thereby the control unit 30 identifies the tag identification information of the tag T. When the recovery terminal device 3 is a cashier terminal, it is preferable that reading by the reading unit 35 is performed and the process of step S313 is performed by the selection of the lost article return button 333 included in the cashier screen 331 of FIG. 11.

The control unit 30 causes the display unit 33 to display an input screen of password for taking over (step S314), and accepts the password input by the operation unit 34 (step S315). In step S315, the control unit 30 may further accept input of account information (telephone number, login information, etc.). When the user carries the information terminal device 4, an image, such as a barcode, obtained by imaging the account information or the password is made to display on the display unit 43 of the information terminal device 4, the reading unit 35 reads this as the account information or the password, and thus the control unit 30 may accept input.

The control unit 30 communication-connects to the recovery support server 2 (step S316), and transmits, to the recovery support server 2, an authentication request as to whether or not the owner is a valid owner based on the tag identification information of the tag T extracted in step S313 and the password accepted in step S315 (step S317). In step S317, if the account information is input in step S315, it may be transmitted together.

Upon receiving the authentication request (step S216), the recovery support server 2 executes the authentication process based on the password received in step S211 (step S217). In the authentication process, the recovery support server 2 may further make an inquiry to the transaction server 1 to verify account information. The recovery support server 2 transmits the result of the authentication process to the recovery terminal device 3 (step S218). A face photograph for personal identification may be registered in advance in the recovery support server 2, and the authentication process may be performed based on this. In this case, the face photograph is transmitted to the recovery terminal device 3, and the face photograph is displayed for the staff confirmation, so that the authentication is performed by the visual check of the staff.

At the recovery terminal device 3, the result of the authentication process is received (step S318), and if the result is successful, the staff hands the article. If the article is locked in a locker, it may be unlocked, and if the article is stored in a warehouse, it may be transported to a receiving place. Upon completion of handing and receiving, the recovery terminal device 3 notifies the recovery support server 2 of recovery completion (step S319), and communication is disconnected (step S320).

Upon receiving the notification of recovery completion (step S219), the recovery support server 2 deletes the storing of the tag identification information of the corresponding tag T as a tag of the article to be recovered (step S220), and further notifies the transaction server 1 of recovery completion (step S221).

Upon receiving the notification of recovery completion (step S134), the transaction server 1 updates the tag status information of the tag identification information of the tag T associated with the account information to be returned to “possessed” (step S135), and ends the process.

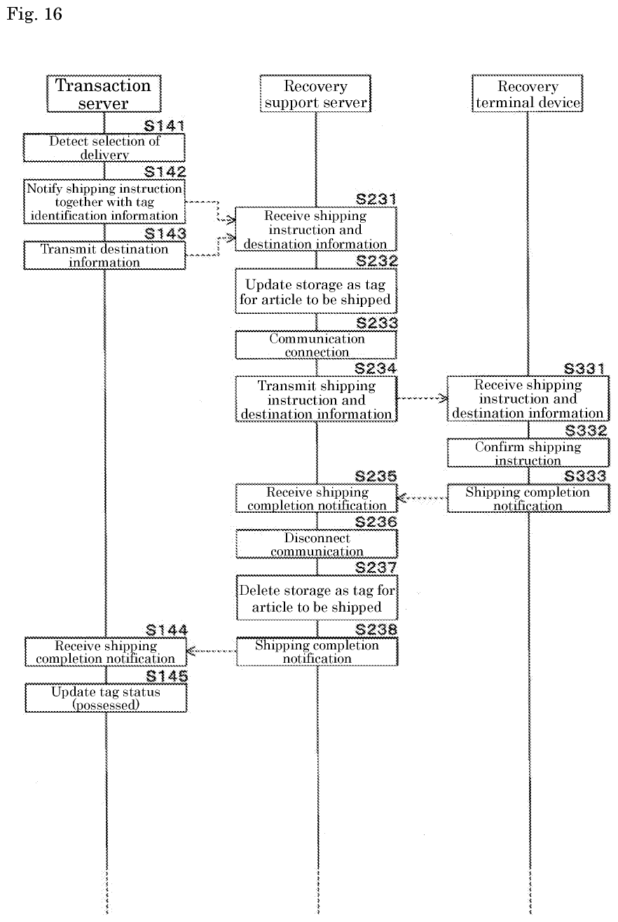

Described below is the case where delivery (delivery) is selected. FIG. 16 is a sequence diagram showing another example of the procedure of the recovery process performed in the physical distribution system 100.

The transaction server 1, when having detected that the delivery has been selected (step S141), transmits a shipping instruction to the recovery support server 2 together with the tag identification information of the target tag T (step S142). The control unit 10 of the transaction server 1 transmits the address or the destination information that is the designated delivery destination to the recovery support server 2 based on the account information associated with the target tag T (step S143). The destination information may be imaged and transmitted as a delivery slip.

In the recovery support server 2, when the shipping instruction and the destination information are received (step S231), the control unit 20 updates the information of the tag identification information of the tag T of the shipping instruction target stored in the storage unit 21 in step S204 and the identification information of the facility where the article was delivered, as the information of the tag T attached to the article to be shipped (step S232). The control unit 20 communication-connects to the recovery terminal device 3 of the facility where the article was delivered and stored based on the identification information of the facility associated with the tag identification information of the tag T of the shipping instruction target (step S233), and transmits the shipping instruction together with the destination information in association with the tag identification information of the tag T of the article to be delivered (step S234).

In the recovery terminal device 3, when the shipping instruction and the destination information are received together with the tag identification information of the target tag T (step S331), the control unit 30 displays the information regarding the tag T to be shipped on the display unit 33, and causes the staff of the facility or the carrier device of the material handling system to confirm that the shipping process is necessary (step S332). The staff member or the carrier device of the material handling system, which has recognized the shipment, inputs shipping completion through the operation unit 34 when performing a shipping procedure based on the received destination information. The control unit 30, when having accepted the operation of the shipping completion input, notifies the recovery support server 2 of the shipping completion (step S333).

In the recovery support server 2, upon receiving the notification of shipping completion (step S235), the communication connection is disconnected (step S236), and the control unit 20 deletes the information of the tag identification information of the tag T updated and stored in the storage unit 21 in step S232 and the identification information of the facility where the article was delivered (step S237). The control unit 20 notifies the transaction server 1 of the shipping completion (step S238).

In the transaction server 1, upon receiving the notification of shipping completion (step S144), the tag status information of the tag identification information of the tag T associated with the account information is updated so as to return to “possessed”, “being recovered by delivery”, or the like (step S145), and the process ends.

When it is selected to submit, it is recovered in the same manner as the procedure shown with reference to FIG. 16. However, it is assumed that the article is recovered at a mail-order service warehouse. The delivery company in the mail-order service may go to the facility where the article was delivered and recover it together with other deliveries. The transaction after recovery is similar to the procedure for submission in the mail-order service, and the sales are returned to the user who is the original owner. Also when it is selected to dispose, the recovery destination may be the mail-order service warehouse or a specific designated address, or may be disposed together with other waste at the place where the article was picked up and delivered.

Regardless of whether recovery, delivery, submission, or disposal is selected, if the third party who has picked up is a specific member of the mail-order service and is registered as a finder in the recovery terminal device 3, the transaction server 1 may present a screen to the user to arbitrarily select whether or not to pay a thank-you payment to the finder. Thank-you may be given by points or the like of mail-order service.

In this way, by associating the account information in the existing mail-order service with the tag identification information of the tag T at the time of purchase, it is possible to minimize the burden on the user and support the recovery of lost articles. By incorporating a recovery support server 2 and a recovery terminal device 3 for realizing recovery support of articles in a physical distribution system 100 including a mail-order service, a convenience store that continues to operate with an uninterruptible power supply 5, a facility in which an ATM and the like are installed, it becomes possible to enhance the convenience and spread of the lost article notification service.

In the present embodiment, when an article is lost, the staff of a facility where the article was recovered notified that the article was picked up from the recovery terminal device 3, assuming that, the article is delivered to a facility such as a convenience store or a station of public transportation by a well-intentioned third party. It is not limited to being picked up in good faith, and it may be notified to the user via the recovery support server 2 that, when the lost article was about to be illegally used, the recovery terminal device 3 has detected this and notified it, so that the lost article was found. Specifically, when a tag T is attached to an article used, the recovery terminal device 3 reads the tag identification information, collates it with the tag identification information of the tag T for which the lost notification has been issued, and if it is the tag T for which the lost notification has been issued, stops using it and notifies it. This is useful because the illegal use can be detected when the target article is a credit card, a prepaid card, or the like. When the lost article is picked up or is illegally used, the notification destination may be not only the user but also the card business operator or the operator of the recovery support server 2.

### First Modification

The tag T is not limited to the mode in which the tag T is attached as an article purchased through the mail-order service as in the above-described embodiment or purchased by itself. For example, the tag T may be issued at a cashier terminal when the purchaser purchased the article. In this case, the user-specific information associated with the tag identification information of the tag T is not the account information of the mail-order service but the user information used in the payment service called so-called electronic money.

When a user purchases a miscellaneous item that is carried such as an umbrella at a convenience store, the user may select to issue the tag T at the time of payment so that the tag T can be used on the spot. In this case, the display screen 33 of the recovery terminal device 3 displays a confirmation screen as to whether or not to use the notification service at the time of loss. When the user selects to use it, the recovery terminal device 3, as described above, makes a payment with electronic money. The staff of the convenience store uses the reading unit 35 to read the tag identification information of the tag T provided as an accessory and makes a payment. The tag T may be issued as a part of the receipt. The recovery terminal device 3 transmits the payment information together with the tag identification information of the tag T to the transaction server 1 that provides the payment service, and the transaction server 1 executes the process of storing the user information and the tag identification information of the tag T in association with each other. The staff hands the tag T together with the product (umbrella) to the user who is the purchaser. The user attaches the tag T to the purchased product and uses it. Subsequent processing is the same as that of the above-mentioned embodiment.

Similarly, when a user purchases a souvenir at the station premises or in a store around the station, even if he/she selects to issue a seal-like tag T when making a payment with electronic money, it may be attached to the souvenir package on the spot. Even if the user has left the souvenir on the train, the railway company official or staff reads the tag T by using the recovery terminal device 3 so that the user can know at which station the souvenir was picked up, and in some cases can perform delivery procedures.

The association and storage of the account information (user specification information) and the tag identification information are performed by the transaction server 1 in terms of handling personal information. Alternatively, the recovery support server 2 capable of exchanging the information of the tag identification information may collect the account information of the user who received issuance of the tag T from each transaction server 1 and store the collected account information in association with the tag identification information of the tag T issued to the user.

The recovery support as described above may be applied not only to lost articles but also to the package itself addressed to the user in the physical distribution system 100. For example, the recovery support can be applied to the recovery in a case where the delivery destination of the article purchased through the mail-order service provided by the transaction server 1 is the convenience store designated by the user. When the article arrives at the convenience store, the staff performs an operation corresponding to this at the recovery terminal device 3 to notify the user via the recovery support server 2. This will facilitate the recovery of package from the convenience store. The delivered package and lost article may be collected in a designated convenience store.

### Second Modification

The association and storage of the tag identification information of the tag T and the account information further makes it possible to link with other services. Other services use a reader (trigger coil, etc.) that can read the tag identification information from the tag T, a beacon receiver, or the like, and are performed based on the detection of existence of an article with the tag T or an article with the tag T built therein and the identification of tag T. For example, when the tag T is detected, it is possible to realize a system that notifies the detection to the account information corresponding to the tag identification information. This is a tracking service for notifying the account information together with the place of the detected gate or beacon receiver only when it is registered as lost or stolen due to a lost notification. A camera linked to a gate or a beacon receiver may be installed, and when a tag T in which loss or theft is registered is detected, a picture may be taken and the account information may be notified together with the photograph or the moving image. The reader may be mounted on the UPS of the outdoor camera or CCTV camera. The additional software module may be provided by the UPS provider. If the target article in which loss or theft is registered is a credit card, cash card, or electronic money, a notification may be given to the card company, financial institution, or electronic money management company to stop the payment of these.

If the reader is installed at the gate of the toll gate and the presence of the tag T is detected and the tag T is identified at this gate, payment may be made by the account information associated with the identification information of the tag T, and it may be linked with a service in which opening and closing of the gate is controlled. The gate may be mounted with or connected to the UPS. The additional software module may be provided by the UPS provider. Such a gate can be applied to parking lots, bicycle parking lots, toll roads, etc. If the loss or theft is registered, it is preferable that even if it is detected at the gate, payment cannot be used, the gate does not open, and further notification is made to the police. Application to such a crime prevention system is also possible.

The disclosed embodiments are illustrative and not limiting. The scope of the present invention is shown by the claims, and includes meanings equivalent to the claims and all modifications within the scope.

### DESCRIPTION OF REFERENCE SIGNS

1: transaction server
10: control unit
11: storage unit
12: communication unit
13: storage device
2: recovery support server
20: control unit
21: storage unit
22: communication unit
201: storage device
3: recovery terminal device
30: control unit
31: storage unit
33: display unit
34: operation unit
4: information terminal device
40: control unit
41: storage unit
43: display unit
44: operation unit
T: tag

1-15. (canceled)

16. A recovery support device, comprising:
a storage unit that stores in advance user specification information for specifying a user of an electronic commerce service that accepts purchase, free transfer, free lending, or rental of an article by electronic commerce;
an extraction unit that extracts user specification information from the storage unit when an article is purchased, transferred free of charge, lent free of charge, or rented through the electronic commerce service;
a determination unit that determines whether or not the article is a tag target article or the article itself is a tag;
a storage processing unit that stores, when the determination unit determines that the article is a tag target article or the article itself is a tag, tag identification information individually attached to the tag in the storage unit in association with the user specification information extracted by the extraction unit;
a reception unit that receives a detection notification including the tag identification information; and
a notification unit that notifies the user and/or a system operator of the detection based on the user specification information associated with the tag identification information included in the received detection notification.

17. The recovery support device according to claim 16, further comprising,
an acceptance unit that accepts purchase, free transfer, free lending, or rental of an article, wherein
the acceptance unit further accepts a selection as to whether or not to receive a notification by the notification unit based on the user specification information when the article is lost or illegally used.

18. The recovery support device according to claim 16, wherein the notification unit includes an interface that accepts a selection from among options including at least two of recovery, delivery, submission, and disposal of an article.

19. The recovery support device according to claim 16, wherein the detection notification includes information indicating at least any of a place where an article was picked up/delivered or illegally used and a place where the article is stored.

20. The recovery support device according to claim 19, wherein the notification unit sends a map showing the place to the user and/or the system operator.

21. A method for providing a tag that readably stores tag identification information, the method comprising:
storing, when the tag is purchased, or an article that is a tag target article is purchased, transferred free of charge, lent free of charge, or rented through an electronic commerce service provided from a transaction server, user specification information for specifying a user of the electronic commerce service in association with the tag identification information in a storage unit of the transaction server or a storage unit of a recovery support server that provides the tag identification information to the transaction server; and
providing a user with a tag corresponding to the tag identification information associated with the user specification information.

22. The method for providing a tag according to claim 21, wherein the user specification information and the tag identification information are further stored in association with a tag status in the storage unit of the transaction server or the storage unit of the recovery support server.

23. The method for providing a tag according to claim 21, wherein the transaction server accepts a selection as to whether or not to receive a notification based on the user specification information when the article arrives at a destination.
